(19) United States
(12) Patent Application Publication
(10) Pub. No.: US 2011/0131885 A1
(43) Pub. Date: Jun. 9, 2011

(54) MOVABLE HOLDER

(75) Inventors: Shinichi Ajiki, Tokyo (JP); Kazuyoshi Oshima, Tokyo (JP)

(73) Assignee: SUGATSUNE KOGYO CO., LTD., Chiyoda-ku, Tokyo, JP (JP)

(21) Appl. No.: 12/680,768

(22) PCT Filed: Oct. 2, 2008
(86) PCT No.: PCT/JP2008/067937

§ 371 Date: Mar. 30, 2010

(30) Foreign Application Priority Data
Oct. 3, 2007 (JP) 2007-259438

(51) Int. Cl. E05F 1/12; E05F 1/10

(52) U.S. Cl. 49/386

(57) ABSTRACT

A movable holder includes first and second mount members 20 and 22 to be attached to a door 3 and a case 2, respectively and two link arms 30 and 32 pivotally supported between the first and second mount members, the door being held on the case 3 so as to movably move forward and backward the door 3 between a position where the door closes the case and a position where the door is opened from the case and is adapted to automatically urge the link arms 30 and 32 to the door closed position or the door opened position when the link arms 30 and 32 are even slightly shifted from the half-opened position to the closed position or the opened position and includes a swinging arm 44 having one end pivoted on the amount member 20 adjacent to one end of the link arm 30 and the other end sliding along an elongated groove 48G in the link arm 30 and an expansion/contraction spring 42 is disposed within the link arm 30 so as to urge the swinging arm 44 to the closed position or the opened position. This prevents the appearance of the door opening and closing mechanism from being lowered and finger or fingers from being placed into the movable holder and enables the movable holder to be more easily attached and be more compacted.

### TECHNICAL FIELD

This invention relates to a movable holder such as a door opening/closing holder to move forward and back a movable member such as a door relative to a stationary member such as an opened case to thereby move the movable member close to or far away from the stationary member, and more particularly this invention relates to a movable holder to automatically urge a movable member to a position shifted from a neutral position between a position where the movable member is close to and far away from a stationary member and a position where the movable member is far away from the stationary member when the movable member is even slightly shifted from the neutral position.

### BACKGROUND OF THE INVENTION

The movable holder of this kind is so designed to be urged that when the door is to be held at a position where an opening of the case is closed by the door moving close to the opening of the case or at a position where the opening of the case is opened by the door moving far away from the case, the door is automatically opened by an operation to manually open the door midway of a door opening direction (one neutral-shifted position where the door is slightly shifted from the neutral position in the door opening direction) and automatically closed by an operation to manually close the door midway of a door closing direction (another neutral-shifted position where the door is slightly shifted from the neutral position in the door closing direction).

This movable holder generally includes a link arm having both ends pivotally supported on the door and the case between them. The link arm is adapted to movably move forward and backward between a first position (a closed position) where the door gets closer to the case and a second position (an opened position) where the door gets far away from the case. The link arm is provided with resilient urging means comprising a spring or a combination of a spring and a swinging arm to automatically pivotally move the link arm to either of the first position and the second position when the link arm is even slightly shifted to the first position or the second position from a middle position between the first position and the second position.

In one conventional movable holder, the resilient urging means comprises a swinging arm having one end pivotally supported on a free end of the link arm and an expansion/contraction spring connected the other end of the swinging arm so that when the link arm is even slightly shifted in either of directions from the neutral position where the pivotal support portions of the link arm and the swinging arm get straight, the expansion/contraction spring pivotally moves the swinging arm to the shifted dside to thereby automatically urge the movable holder to the opened position or the closed position (see Patent Document 1).

Since the movable holder of such a construction has the expansion/contraction spring disposed so as to pivotally move the free end of the link arm, the expansion/contraction spring could not but be exposed from the link arm and therefore, the expansion/contraction spring is exposed when the door is opened, which disadvantageously causes the appearance of the movable holder to be worsened.

In another conventional movable holder, there are two link arms on the sides of the case and the door and the resilient urging means comprises an expansion/contraction spring provided between the case side link arm and the door so that when the link arm is even slightly shifted in either direction from a neutral position where the movable ends of the two link arms and the expansion/contraction spring arm get straight, the expansion/contraction spring urges the link arms to automatically pivotally move to the opened position or the closed position (see Patent Document 2).

The movable holder of such a construction has the expansion/contraction spring hidden on the back side of the door when the door is opened, but the expansion/contraction spring can appear from the side of the door, which similarly causes the appearance of the movable holder to be worsened. Furthermore, since the link arms and the expansion/contraction spring are in the intersection state, a finger or fingers are accidentally placed between the intersection portions.

Further conventional movable holder comprises two link arms provided between the door and the case and the resilient urging means of the movable holder comprises an expansion/contraction spring provided the case side end of one of the link arms and expanded/contracted in accordance with a movement of a movable pin which is slidably engaged into an arc-like groove in a mount portion on the side of the case. When one of the link arms is even slightly shifted in either direction from the middle position (neutral position) of the arc-like groove, the expansion/contraction spring swings the link arm along the arc-like groove to either of the ends whereby the door is automatically urged to the opened position or the closed position (see patent document 3).

Since the movable holder of such a construction has the expansion/contraction spring assembled into the link arms, the appearance is never worsened, but if the mount portion having the arc-like groove is even slightly displaced from a proper mount position (including a vertical position, a horizontal position and an angular position) relative to the case, the closing state of the door and the case is never held properly at the closed position thereof, it will be troublesome to set the mount position and since the mount portion having the arc-like groove contains the expansion/contraction spring, the mount portion disadvantageously gets large-sized and worsens the appearance.
Patent document 1: U.S. Pat. No. 2,717,106 specification
Patent document 2: JP2005-264719A
Patent document 3: JP2-176086A

### DESCRIPTION OF THE INVENTION

It is an object of the invention to provide a movable holder adapted to prevent an appearance from being lowered and a finger or fingers from being placed into the movable holder, to be more easily attached and to make simpler a construction of holding portion of an expansion/contraction spring without being large-sized.

The movable holder of the present invention includes first and second mount members to be attached to a movable member and a stationary member, respectively and two link arms having both ends pivotally supported on said first and second mount members between them, said movable holder being held so as to movably move forward and backward between a first position where said movable member is close to said stationary member and a second position where said movable member is far away from said stationary member and being further provided with resilient urging means including an expansion/contraction spring to urge said two parallel link arms to be automatically pivotally moved to either of said first and second position when said two link arms are even slightly shifted from a mid-position between said first and second positions, said movable holder characterized in that said resilient urging means further includes a swinging arm having one end pivoted adjacent to a pivoted portion of one end of one of said link arms at said first mount member and other end sliding along a linear guide provided in said one link arm and said expansion/contraction spring is disposed between said one link arm and said swinging arm so as to urge said swinging arm along said linear guide to said first or second position of said link arms.

In the movable holder of the invention, the expansion/contraction spring may be preferably disposed within said one link arm. The linear guide may be in the form where it comprise an elongated groove provided in the one link arm and the other end of the swinging arm may have a pivotal pin slidably engaged into the elongated groove. In this case, the movable end of the expansion/contraction spring may be preferably connected with the pivotal pin.

In accordance with the invention, since the expansion/contraction spring is arranged between one of the link arms and the swinging arm so that the other end of the swinging arm is urged along the linear guide provided in the one link arm, the expansion/contraction spring never protrudes so much from the one link arm and therefore the appearance is never prevented from being lowered and the finger or fingers are prevented from being placed in the movable holder. Furthermore, since the swinging arm following the expansion/contraction spring moves along the straight linear guide, the movement of the swinging arm can be made more smoothly in comparison with the movement of the swinging arm along the arc-like groove. In addition thereto, the structure of the guide portion is simplified and small-sized and the attachment of the movable holder can be more easily made because there are not required such parts as are to be attached while taking care of the mount position.

### BRIEF DESCRIPTION OF THE DRAWINGS

FIG. 1 is a schematic diagram of a cabinet using a movable holder of the invention;

FIG. 2 illustrates transition of an operation of the cabinet using the movable holder according to one form of embodiment of the invention with a case thereof shown in cross section, FIG. 1(A) is a cross sectional view of the cabinet having the door closed position, FIG. 1(B) is a cross sectional view of the cabinet having the door half-opened position and FIG. 1(C) is a cross sectional view of the cabinet having the door opened position;

FIG. 3 is an enlarged cross-sectional back view of one of the arm links relevant to resilient urging means used for the movable holder of FIG. 2 with only the arm body shown in cross section and seen from the back side of the door;

FIG. 4 illustrates the state of the movable holder when the door is in the closed position, FIG. 4(A) is a cross sectional view of the cabinet and FIG. 4(B) is a cross-sectional view of the link arm having the resilient urging means;

FIG. 5 illustrates the state of the movable holder when the door is half-opened wherein FIG. 5(A) is a cross-sectional view of the cabinet and FIG. 5(B) is a cross-sectional view of the link arm having the resilient urging means; and

FIG. 6 illustrates the state of the movable holder when the door is opened wherein FIG. 6(A) is a cross-sectional view of the cabinet and FIG. 6(B) is a cross-sectional view of the link arm having the resilient urging means.

### BEST MODE OF EMBODIMENT OF THE INVENTION

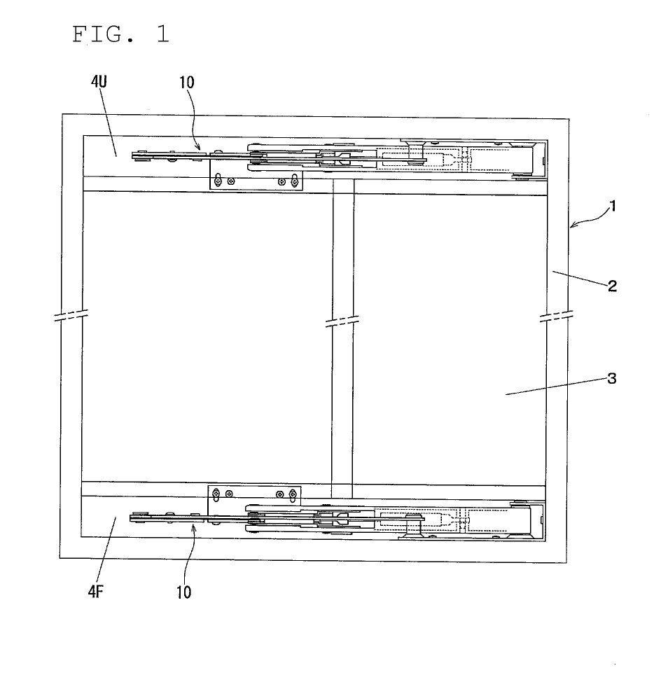

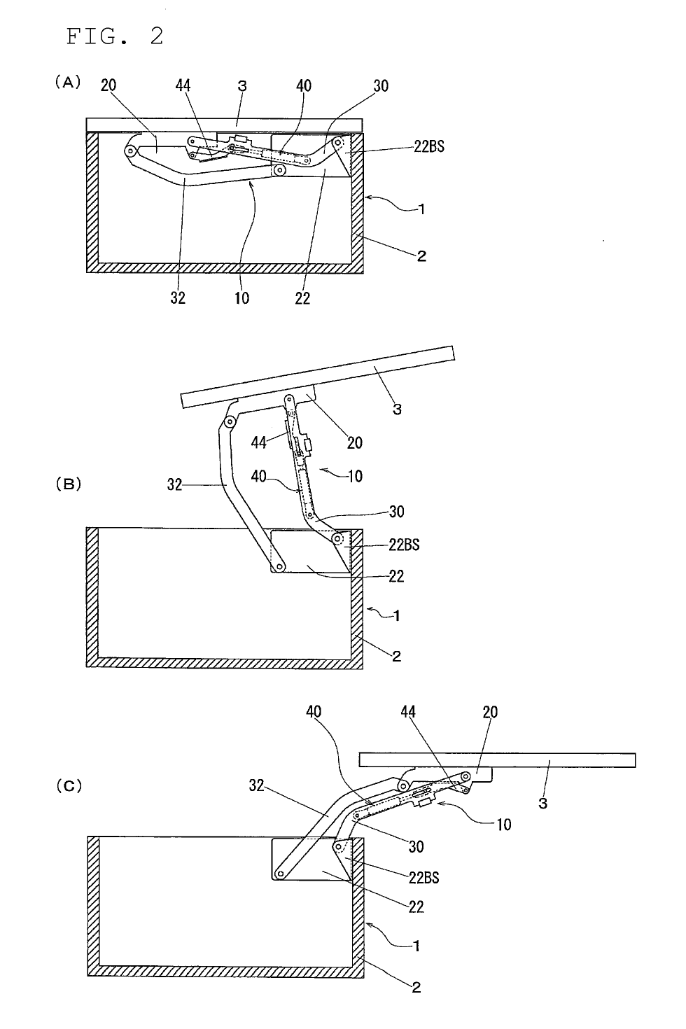

There is illustrated in FIGS. 1 and 2 a cabinet 1 using a movable holder 10 constructed in accordance with the mode of preferred embodiment of the invention. The cabinet 1 comprises a case (stationary member) 2 and a door (movable member) 3. The movable holder 10 is disposed within a space of a top board 4U and within a space of a floor board 4F and holds the door 3 on the case 2 so that the door 3 is opened or closed relative to the case 2.

As shown in FIG. 2, the movable holder of the invention comprises first and second mount members 20 and 22 to be attached to the door (movable member) 3 and the case (stationary member) 2, respectively and two parallel link arms 30 and 32 having both ends pivotally supported on the first and second mount members 20 and 22 between them whereby the door 3 is movably held on the case 2 so as to movably move forward and backward the door 3 between a first position where the door (movable member) 3 is close to the case (stationary member) 2 (the door closed position of FIG. 2(A) in the illustrated form) and a second position where the door (movable member) 3 is far away from the case (stationary member) 2 (the door opened position of FIG. 2(C) in the illustrated form).

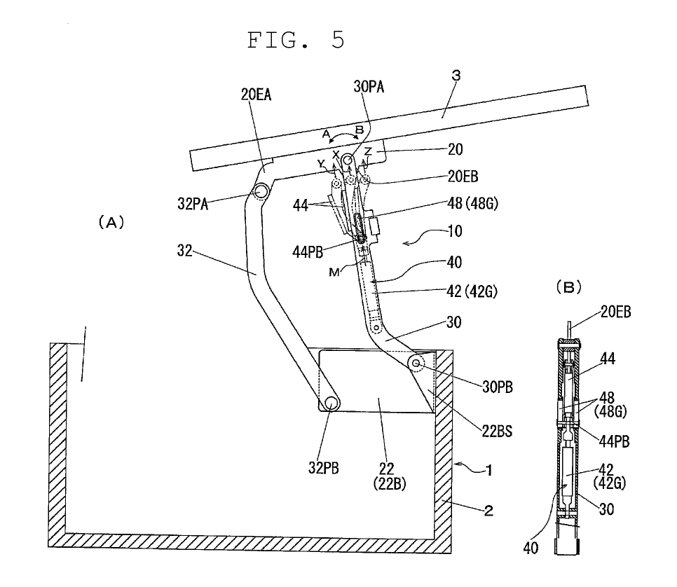

Furthermore, the movable holder 10 is further provided with resilient urging means 40 including an expansion/contraction spring 42 to urge the parallel two link arms 30 and 32 to be automatically pivotally moved to either of the first and second positions when the two link arms 30 and 32 are even slightly shifted from the middle position (see FIG. 2(B) and FIG. 5) between the first and second positions to the first or second position.

As shown in FIGS. 2, 3 and 4 through 6, the first mount member 20 may be formed of a strip 20B attached to the back face of the door 3 by screws or any other appropriate means. One end 30EA of one link arm 30 of the rink arms 30 and 32 is pivotally supported by a pivotal pin 30PA to the strip 20B and one end 32EA of the other link arm 32 is pivotally supported by a pivotal pin 32PA on a curved extension 20EA of the strip 20B.

Similarly, as shown in FIGS. 2, 3 and 4 through 6, the second mount member 22 may be formed of a rectangular plate 22B attached to the inner face of the case 2 by screws or any other appropriate means. The other end 30EB of the one rink arm 30 is pivotally supported by a pivotal pin 30PB on the rectangular plate 22B and the other end 32EB of the other link arm 32 is pivotally supported by a pivotal pin 32PB on the rectangular plate 22B. As described later, since a part of the resilient urging means 40 is contained in the rink arm 30, the link arm 30 is not in a flat plate form, but in a square-cylindrical form and therefore, the rectangular plate 22 has an auxiliary support 22BS integral to the rectangular plate 22B for supporting the end 30EB of the link arm 30 so as to be held around the auxiliary support 22BS in order to reinforce the support by the pivotal pin 30PB.

The resilient urging means 40 includes a swinging arm 44 having both ends pivotally supported on the link arm 30 and the strip 20B, which is the first mount member 20, adjacent to the pivotal support portion of one end of the link arm 30 in the illustrated form of embodiment. The expansion/contraction spring 42 is disposed between the one link arm 30 and the swinging arm 44 so as to resiliently move the swinging arm 44 in accordance with the movement of the parallel link arms 30 and 32.

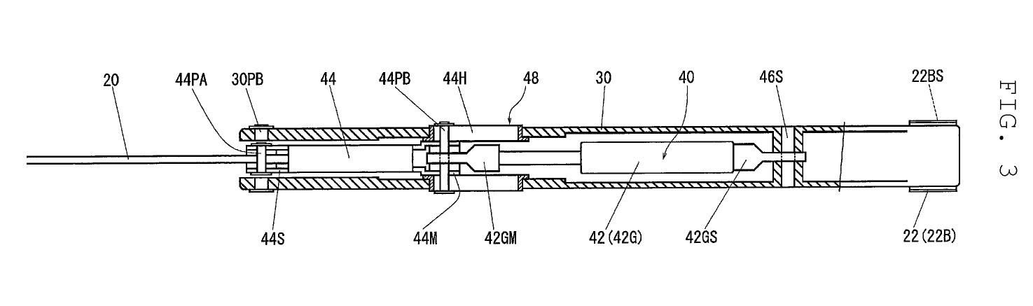

As particularly illustrated in FIG. 3 in details, the fixed end 44S of the swinging arm 44 is pivotally supported on a second extension 20EB of the strip 20B by a pivotal pin 44PA while the movable end 44M of the swinging arm 44 is pivotally supported on the link arm 30 by a pivotal pin 44PB slidably movable along a linear guide 48 provided in the link arm 30.

In the illustrated form, the expansion/contraction spring 42 may comprise a cylinder-like gas spring 42G. The fixed end 42GS of the gas spring is fixed to the link arm 30 by a fixing pin 46S while the movable end 42GM thereof is connected with the pivotal pin 44PB which in turn pivotally supports the movable end 44M of the swinging arm 44 on the link arm 30.

In the illustrated form, the linear guide 48 may comprise an elongated groove 48G provided in the link arm 30. In the elongated groove 48G is slidably engaged the pivotal pin 44PB, which pivotally supports the movable end 44M of the swinging arm 44 on the link arm 30 and connects the movable end 42GM of the gas spring 42G to the link arm 30.

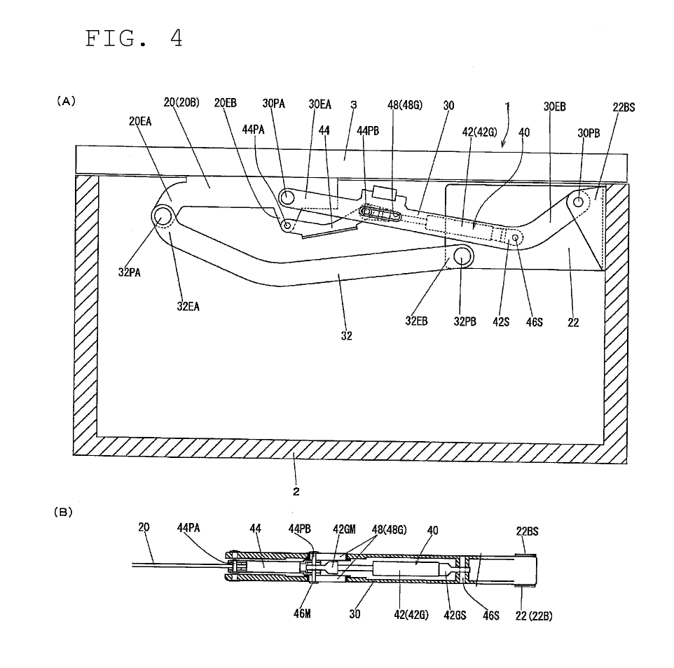

An operation of the movable holder 10 in the aforementioned form of embodiment will be explained with reference to FIGS. 4 through 6. First, in the state where the door 3 closes the opening of the case 2, the parallel link arms 30 and 32 are contained in the folded state within the space of the top board 4U and the floor board 4F of the case 2 as shown in FIG. 2(A) and FIG. 4 and the swinging arm 44 is pulled on the left-hand side of FIGS. 2(A) and 4 (on the side corresponding to a direction of an arrow Y of FIG. 5) by an expansion force of the expansion/contraction spring 42 of the resilient urging means 40. Thus, the door 3 is held in the position (the first position) where the door 3 closes the opening of the case 1.

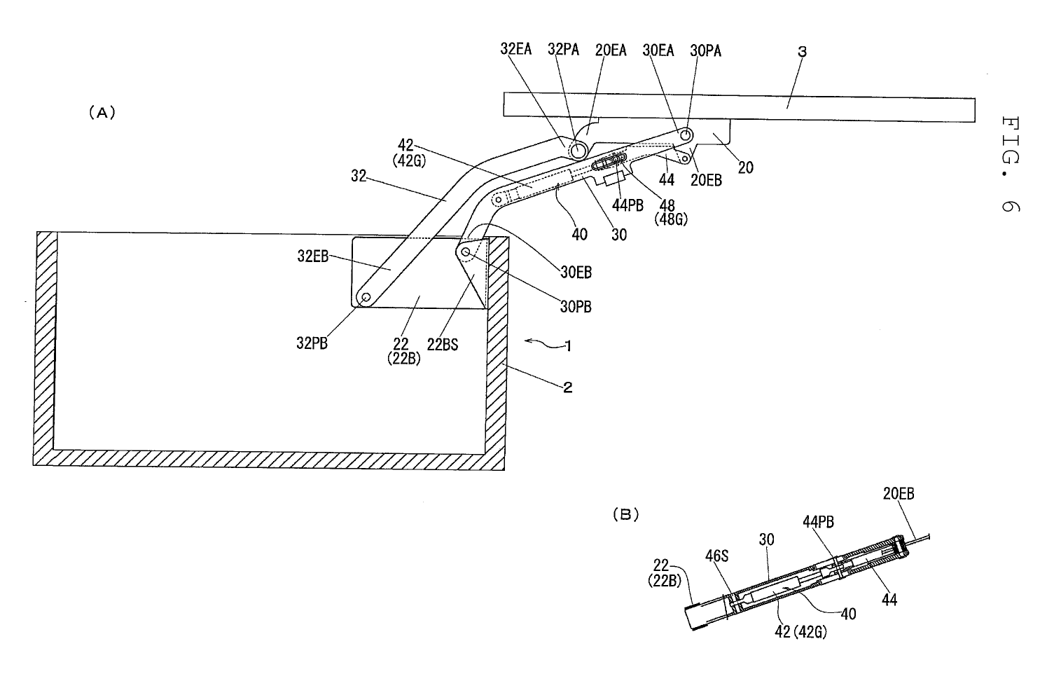

Then, as shown in FIGS. 2(B) and 5, when the door 3 is manually opened from the closed position, the parallel link arms 30 and 32 pivotally move about the center of the pivotal pins 30PB and 32PB on the second mount member 22. Under the circumstances, the swinging arm 44 of the resilient urging means 40 pivotally moves the extension 20EB of the first mount member 20 about the center of the pivotal pin 30PA of the link arm 30 while the expansion/contraction spring 42 is contracted whereby the extension 20EB moves toward the second mount member 22 while inclining the door 3 until there reaches a mid-position (neutral position) of door half-closing where the pivotal pin 30PA of the link arm 30 and the pivotal pins 44PA and 44PB of the swinging arm 44 are aligned in a straight line (the position shown in FIG. 2 (B) and FIG. 5). In this position, the expansion force M acts on the expansion/contraction spring 42 whereby the swinging arm 44 is pushed in the direction X, but the swinging arm 44 cannot move by being blocked by the pivotal pin 30PA of the link arm 30. However, as the door 3 even slightly moves in the door opening direction beyond the mid-position, the action force in the direction Z is applied on the swinging arm 44 due to the expansion force M of the expansion/contraction spring 42 and therefore the first mount member 20 swings in the direction indicated by an arrow A (the counterclockwise direction) whereby the link arms 30 and 32 automatically pivotally move due to a principle of parallel link to reach the opened position (the second position) of the door 3 which is the position as shown in FIG. 2(C) and FIG. 6. Thus, after the door 3 moves beyond the half-open mid-position, the door 3 is automatically opened even though it is relieved from the hand.

Reversely, when the door 3 is to be closed, the door 3 is manually operated in the door closing direction against the expansion force of the expansion/contraction spring 42 from the position of FIG. 2(C) and FIG. 6 to the position slightly beyond the half-opened mid-position of FIGS. 2(B) 2 and 5. This causes the action force in the direction Y to be applied to the swinging arm 44 due to the expansion force M of the expansion/contraction spring 42 and therefore the first mount member 20 swings in the direction indicated by an arrow B (the clockwise direction) whereby the link arms 30 and 32 are similarly urged due to the principle of parallel link in a door closing direction. Thus, the door 3 is automatically closed even though it is relieved from the hand to be thereby returned to the closed position (the first position) as shown in FIG. 2(A) and FIG. 4.

Although, in the aforementioned form of embodiment, the expansion/contraction spring 42 is disposed within the link arm 30, the link arm 30 may be not in the square cylindrical form, but in the flat form so that the expansion/contraction spring 42 may be disposed between the flat link arm 30 and the movable end 44M of the swinging arm 44.

As aforementioned, since the expansion/contraction spring 42 to urge the link arms 30 and 32 toward either of the door closed position and the door opened position is disposed between the link arm 30 and the swinging arm 44 to move along the linear guide 48 of the link arm 30, the expansion/contraction spring 42 never protrudes from the link arm 30 so much, which causes the expansion/contraction spring to be exposed outside and there never occur the reduction of the appearance and the accident that the finger or fingers are pulled into the movable holder. Furthermore, since the swinging arm 44 moving in accordance with the movement of the expansion/contraction spring 42 moves along the elongated groove 48G of the linear guide 48, the movement of the swinging arm 44 more smoothly in comparison to the prior art in which the swinging arm moves along the arc-like groove and in addition thereto, the guide portion can have the simpler construction and the smaller size. Also, the setting of the attachment position of the first and second mount members 20 and 22 and the attachment operation thereof can be easily made.

Since the pivotal pin 44PB attached to the movable end of the swinging arm 44 makes a straight line movement within the elongated groove 48G of the linear guide 48 when the door 3 is to be opened or closed, the movement of the swinging arm 44 accompanied by the expansion/contraction of the expansion/contraction spring 42 can be smoothly achieved by resistance lower than the arc-like movement within the arc-like groove in the prior art.

In the aforementioned form of embodiment, the expansion/contraction spring 42 is in the form of the gas spring 42G, but may be other than the gas spring n spring 42. Also, it is in the form of push spring, but it may be in the form of pull spring. In the latter case, the expansion/contraction spring 42 will be positioned in the opposite side relative to the linear guide 48. Furthermore, although, in the illustrated form of embodiment, the expansion/contraction spring 42 is connected to the pivotal pin 44PB of the swinging arm 44, it is not required to be connected to the pivotal pin 44PB, so long as the pivotal pin 44PB can be urged so as to move along the linear guide 48.

### INDUSTRIAL APPLICABILITY

In accordance with the invention, since the expansion/contraction spring for urging the link arms to the first or second position is arranged between the link arm and the swinging arm moving along the linear guide, the expansion/contraction spring never protrudes so much from the link arms and therefore the appearance is never prevented from being lowered and the finger or fingers are prevented from being placed into the movable holder. Furthermore, since the swinging arm following the expansion/contraction spring moves along the linear guide, the movement of the swinging arm can be made more smoothly in comparison with the movement of the swinging arm along the arc-like groove. In addition thereto, the guide portion has a simpler structure and a smaller size and the attachment of the movable holder can be more easily made because there are not required such parts as are to be attached while taking care of the attachment position. Thus the invention has the higher industrial applicability.

1. A movable holder including first and second mount members to be attached to a movable member and a stationary member, respectively and two link arms having both ends pivotally supported on said first and second mount members between them, said movable holder being held so as to movably move forward and backward between a first position where said movable member is close to said stationary member and a second position where said movable member is far away from said stationary member and being further provided with resilient urging means including an expansion/contraction spring to urge said two parallel link arms to be automatically pivotally moved to either of said first and second position when said two link arms are even slightly shifted from a mid-position between said first and second positions, said movable holder characterized in that said resilient urging means further includes a swinging arm having one end pivoted adjacent to a pivoted portion of one end of one of said link arms at said first mount member and other end sliding along a linear guide provided in said one link arm and said expansion/contraction spring is disposed between said one link arm and said swinging arm so as to urge said swinging arm along said linear guide to said first or second position of said link arms.

2. A movable holder as set forth in claim 1, and wherein said expansion/contraction spring is disposed within said one link arm.

3. A movable holder as set forth in claim 1, and wherein said linear guide comprises an elongated groove provided in said one link arm and the other end of said swinging arm has a pivotal pin slidably engaged into said elongated groove.

4. A movable holder as set forth in claim 3, and wherein the movable end of said expansion/contraction spring is connected with said pivotal pin.

5. A movable holder as set forth in claim 2, and wherein said linear guide comprises an elongated groove provided in said one link arm and the other end of said swinging arm has a pivotal pin slidably engaged into said elongated groove.

6. A movable holder as set forth in claim 5, and wherein the movable end of said expansion/contraction spring is connected with said pivotal pin.
